(19) United States
(12) Patent Application Publication
(10) Pub. No.: US 2017/0176134 A1
(43) Pub. Date: Jun. 22, 2017

(54) Defense Device

(71) Applicant: Cory A. Hulet, Bryan, OH (US)

(72) Inventor: Cory A. Hulet, Bryan, OH (US)

(21) Appl. No.: 15/379,611

(22) Filed: Dec. 15, 2016

Related U.S. Application Data
(60) Provisional application No. 62/269,168, filed on Dec. 18, 2015.

(51) Int. Cl. F41B 15/00; F41B 15/08; A61H 39/04

(52) U.S. Cl. CPC F41B 15/00; A61H 39/04; F41B 15/08

(57) ABSTRACT

A non-lethal defense device is described for controlling difficult individuals. The device has an elongated body with an elongated opening positioned in the body. A support section of the body is positioned adjacent the opening. An elongated surface is defined by a side of the opening that is spaced apart from the support section. The elongated section is designed for applying a concentrated force that can subdue an aggressor.

### BACKGROUND OF THE INVENTION

The invention is directed to a non-lethal defense tool that can be used to deal with an aggressor. It is designed for use by police military and other security personnel that needs to control difficult individuals. In today's society there is a need for non-lethal ways to control disruptive individuals. Use of lethal force on individuals is under intense scrutiny and can only be used in the most extreme circumstances. Unfortunately, there are very few options available that can be used instead of a gun. And even some of the non-gun options can result in lethal injury when used in extreme situations. Accordingly, there is a need for a non-lethal defense tool or device that can be used to control difficult individuals.

### SUMMARY OF THE INVENTION

A non-lethal defense device is described for controlling difficult individuals. The device has an elongated body with an elongated opening positioned in the body. A support section of the body is positioned adjacent the opening. An elongated surface is defined by a side of the opening that is spaced apart from the support section. The elongated section is designed for applying a concentrated force that can subdue an aggressor.

Other objects and advantages of the present invention will become apparent to those skilled in the art upon a review of the following detailed description of the preferred embodiments and the accompanying drawings.

### BRIEF DESCRIPTION OF THE DRAWINGS

FIG. 1 is a side elevational view of the device of the invention.

FIG. 2 is a cross section view taken along line A-A in FIG. 1.

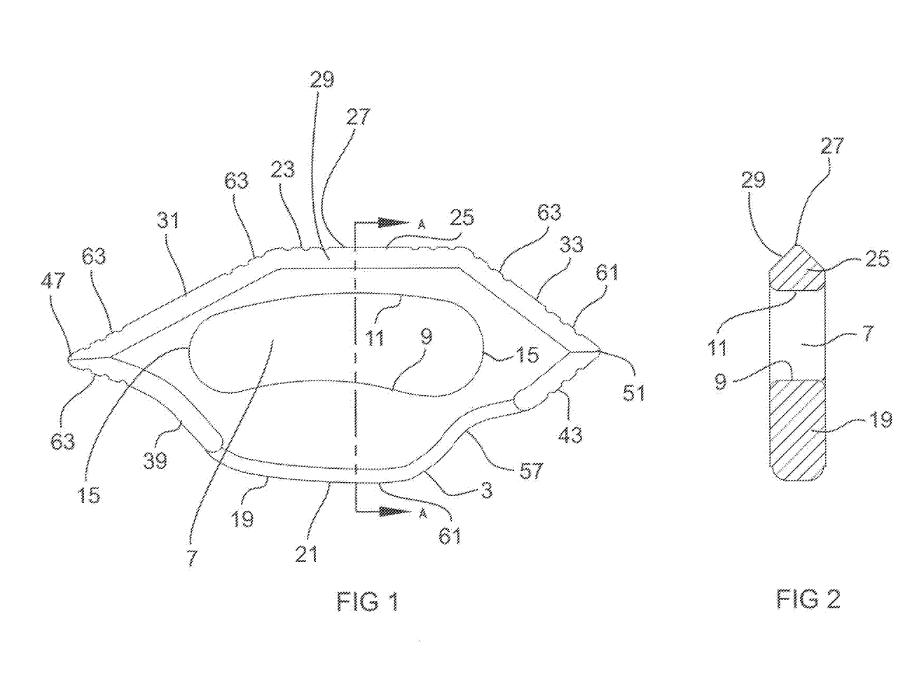

### DETAILED DESCRIPTION OF THE PREFERRED EMBODIMENT(S)

The invention is directed to a nonlethal defense tool or device that is designed to be used by police or military personnel to subdue an aggressor.

The details of the invention will be more readily understood by referring to the attached drawing in connection with the following description.

The tool of the present invention is designed to be primarily used as a defense tool. For the sake of simplicity, the tool will be described with respect to defensive uses. It should be appreciated that the tool can be used for other purposes such as acupressure therapy, massage therapy, kitchen applications and many other applications.

The non-lethal defense tool or device 1 has an elongated body 3 that is made from high density polyethylene (HDPE) or other similar materials having similar properties. The elongated body has an elongated opening 7. The elongated opening has a first side 9 and a second side 11. A radiused section 15 is positioned at each end of the elongated opening and joins the first side 9 to the second side 11.

A support section 19 is positioned adjacent the first side 9 of the elongated opening 7. The support section defines a support surface 21 that is spaced apart from the first side 9 of the elongated opening. The support section 19 is designed to fit into the palm of a user that is using the device 1. The support surface 21 is designed to enforce the palm on the hand of the user. The fingers of the user are designed to extend into the elongated opening to allow the user to firmly grip the device 1. The first side 9 of the elongated opening 7 can have a curved surface to provide a more comfortable shape to accommodate the fingers of the user when gripping the device.

Positioned along the second side 11 of the elongated opening is a guard section 23. The guard section extends along a substantial portion of the second side 11. A first pushing surface 25 is defined by the portion of the guard section 23 that is spaced apart from the elongated opening 7. The first pushing surface has a chamfered section 29 that forms an edge 27 that has a thickness or width from about 0.05 to about 0.075 of an inch. The chamfered portion of the first pushing section has a chamfer angle from about 30 to about 60 degrees. A second pushing surface 31 extends from one end of the first pushing surface 25 at an angle from about 20 to about 40 degrees. A third pushing surface 33 extends from the other end of the first pushing surface at an angle from about 35 to about 55 degrees. The second and third pushing surfaces are angled from the first pushing surface 25 in a direction towards the support section 19. The second and third pushing surfaces are chamfered in the same manner as the first pushing surface. The chamfer for these surfaces is usually done at substantially a 45 degree angle, but it should be appreciated that other angles may be used.

A first pulling surface 39 extends from the support section 19 in a direction towards the second pushing surface 31. The first pulling surface is disposed at an angle of from about 20 to about 40 degrees to the support surface 21. A second pulling surface 43 extends from the support surface 19 in a direction towards the third pushing surface 33. The second pulling surface is disposed at an angle from about 35 to about 55 degrees with respect to the support surface 21. The second and third pushing surfaces in the first and second pulling surfaces are chamfered in the same manner as the first pushing section and define an edge 27 that has generally the same width as the edge 27 on the first pushing surface 25. The first pulling surface 39 in this second pushing surface 31 come together at a first point 47. The second pulling surface 43, the third pushing surface 33 come together at a second point 51. The first and second points are rounded and have a radius from about 0.08 to about 0.12 of an inch. The first and second points are designed to be relatively blunt and rounded to avoid puncturing the skin of an aggressor upon which the device may be used. The first pulling surface 39 may have a curved shape.

A detent 57 can be positioned the support section 19 adjacent the second pulling surface 43. The detent is designed to accept the thumb of the user of the device 1. A plurality of teeth 63 can be positioned on the first, second and third pushing surfaces. A plurality of teeth 63 can be positioned upon the first and second pulling surfaces. The teeth 63 are a series of notches having a depth from about 0.0625 to about 0.125 of an inch. The teeth are spaced apart from about 0.125 to about 0.25 an inch. A textured surface 61 can be provided on the surfaces of the elongated body 3 to provide a better gripping surface for the user of the device.

In use the device can be used by either hand as the elongated opening 7 and the support section 19 are designed to allow for multiple hand sizes as well as hands that are covered by gloves. The detent 57 allows the thumb of the user to be positioned on the device in a way that provides excellent ergonomic strength based on the bone structure of the wrist in the hand of the user. The design of the device allows the bones in the wrist and hand to be in a straight alignment which provides a strong and sturdy positioning of the hand on the device. The guard section 23 functions to protect the finders and hand of the user when the device is put in use. The edge 27 that is positioned on the first pushing surface 25, second pushing surface 31, third pushing surface 33, first pulling surface 39 and second pulling surface 43 can be pressed into many of the bodies pressure points as well as other sensitive areas of the body to cause discomfort and pain in an aggressor. The width of the edge 27 is designed to increase the pounds per square inch of pressure that can be applied to an aggressor. The edge 27 works like a percussion hammer that doctors use to disrupt the body's nervous system, inducing an involuntary reflex. The disruption of the body's nervous system is very effective at encouraging compliance in an aggressor. First and second points 47, 51 on each end of the device are also designed to provide nerve disruption when pushed against pressure points on an aggressor. The first and second points have a radius that provides for good nerve disruption while making it unlikely that there will be any penetration of the skin of the aggressor. The first pulling surface 39 and the second pulling surface 43 can be used to grip the body of the aggressor and to pull the aggressor to a desired location. The curved configuration of the first pulling surface 39 of the device allows the aggressor to be engaged in a way that the tool will assist in moving the aggressor to a desired location. The plurality of teeth 63 can be used to collect forensic evidence such as hair, skin, particles and other evidence from an aggressor. The collection of forensic evidence can assist in the positive identification of the aggressor in later proceedings.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

1. A defense device comprising:
an elongated body;
an opening positioned in the body, the opening designed to receive fingers of a user of the device,
a support section positioned adjacent the opening, the support section designed to fit in a hand of the user of the device;
an elongated surface defined by a side of the opening that is in spaced apart opposed relationship to the support section, the elongated section being positioned to be applied to an aggressor to apply a concentrated force that can subdue the aggressor.

2. The device of claim 1 wherein the elongated surface has a chamfered edge that defines a force surface that is on a portion of the elongated surface that is spaced apart from the opening, the force surface functioning to increase the effect of the force that is applied to an aggressor.

3. The device of claim 1 wherein the elongated body forms a point on each side of the opening between the support section and the elongated surface.

4. The device of claim 3 wherein the portion of the elongated body that extends from the elongated surface to the support section that forms the points having a chamfered edge.

5. The device of claim 4 wherein a depression is formed on the section of the elongated body that extends from the support section to form on the points, the depression being disposed to receive a thumb on a hand of the user and to position the hand for increasing the ergonomic strength and force that the hand can apply to the device.

6. The device of claim 5 wherein the points are disposed to apply concentrated force on pressure point of the aggressor.

7. The device of claim 6 wherein the elongated surface has a plurality of indentations, the indentations being disposed to engage the aggressor and to collect forensic evidence from the aggressor.

8. The device of claim 7 wherein the elongated body has a textured surface to provide a good gripping surface for the hand of the user.

9. The device of claim 1 wherein the elongated body is formed of a high density polyethylene.
